(19) United States
(12) Patent Application Publication
(10) Pub. No.: US 2020/0115519 A1
(43) Pub. Date: Apr. 16, 2020

(54) ORGANIC SUBSTRATES HAVING IMPROVED WEATHERABILITY AND MAR RESISTANCE

(71) Applicant: RADCO INFUSION TECHNOLOGIES, LLC, Toledo, OH (US)

(72) Inventors: Adam Phillips, Ottawa Hills, OH (US); Michael Heben, Ottawa Hills, OH (US); Nikolas Podraza, Toledo, OH (US); Richard Yorde, Howard, OH (US); Rick Anderson, Waterville, OH (US)

(21) Appl. No.: 16/499,655

(22) PCT Filed: Apr. 2, 2018
(86) PCT No.: PCT/US2018/025658

§ 371 Date: Sep. 30, 2019

Related U.S. Application Data
(60) Provisional application No. 62/479,536, filed on Mar. 31, 2017.

(51) Int. Cl. C08J 7/06; C09D 1/00; B29C 59/14

(52) U.S. Cl. CPC C08J 7/065; C09D 1/00; B29K 2701/12; C08J 2369/00; B29C 59/14

(57) ABSTRACT

Provided are polymeric materials that demonstrate excellent mar resistance as well as clarity and weatherability as well as processes for their manufacture. In some aspects a thermoplastic material includes a light stabilizer at or within the surface of the material and a mar resistant coating material layered directly on the surface, optionally without any intermediate primer layer, adhesion promotion layer or material, or other functional layer.

### CROSS REFERENCE TO RELATED APPLICATIONS

This application depends from and claims priority to U.S. Provisional Application No. 62/479,536 filed Mar. 31, 2017 and International Patent Application No. PCT/US2018/025658 filed on Apr. 2, 2018 the entire contents of which are incorporated by reference.

### FIELD

This disclosure relates to the organic substrates with improved weatherability and mar resistance. More specifically, materials and processes for their manufacture are provided that impart superior clarity following exposure to light and simultaneously provide an excellent substrate for the addition of mar resistant coatings that are more effectively adhered to the substrate thereby preventing peeling or loss of substrate contact.

### BACKGROUND

Due to their lighter weight, impact resistance, and ease of shaping, organic resin materials are highly desirable for use in automotive surfaces. Such materials are quickly becoming the standard for bumpers, portions of door panels, or as trim or protection in areas that experience additional wear from rubbing or exposure to the elements.

Use of organic materials as a replacement for glass in automotive or other window surfaces has, however, remained elusive. This is due in part to clear organic materials suffering discoloration during weathering or having inadequate scratch resistance leading to unacceptably opaque or marred surfaces. Several solutions have been proposed to improve both of these shortcomings such as the use of a UV absorber to improve weatherability, and the addition of a scratch resistant coating on the surface of the organic substrate. Unfortunately, achieving success of both incorporation of UV absorbers and successfully adhering a mar resistant coating has been difficult.

Coating materials used for improving mar resistance are typically hydrolyzates or partial hydrolyzates of hydrolyzable organosilanes, or colloidal silica. These materials on their own will successfully impart excellent mar resistance. However, bonding them to substrate materials such as polycarbonates requires a primer layer to allow the inorganic coating material to bond to the organic substrate. While this coating addresses the needed mar resistance, the materials used in such coating layers to provide anti-scratch properties do not impart improved UV weatherability to the underlying organic substrate. To address this problem, the addition of UV absorbers to the inorganic coating material was recently proposed. This, however, also resulted in reduced durability of the coating. In addition, modifying the UV absorber such as with silyl-modification to chemically bond the UV absorber to the siloxane matrix of the coating material did improve UV resistance but significantly reduced the ability of the coating material to resist scratching as well as unacceptably reduced the coating flexibility.

Incorporating UV absorbers into the primer layer has also been attempted. Unfortunately, the presence of these UV absorbers in the primer material reduced the adhesion of the mar resistant coating onto the organic substrate surface. The presence of the UV absorbers in the primer layer also reduced transparency of the final material.

Overall, organic materials or coated organic materials have yet to achieve the necessary light transparency and weatherability against UV radiation to prevent discoloration, and at the same time have excellent scratch resistance such that it can be used as a glass replacement. There is a need for such materials and processes for their manufacture for use in many applications including automotive, aviation, and household.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

Provided are mar and weather resistant materials suitable for use in most any external application such as but not limited to automobile parts including headlights, windshields, or other, or any exterior lighting application or application that requires clear material or is subject to environmental degradation over time. The mar and weather resistant materials include a polymerized thermoplastic substrate, the substrate including at least one surface, a light stabilizer within the thermoplastic substrate, and a mar resistant material coated on, optionally directly on, the surface. A hallmark of the materials provided herein as well as the processes used to make them contrasts with prior attempts to make such materials that required a primer or other layer between the surface of the polymerized substrate and the mar resistant coating or special adhesion promoters in the plastic in order to achieve sufficient bonding between the materials. The materials as provided herein are optionally entirely free of any composition between the surface and the mar resistant material that promotes adhesion of the mar resistant material to the surface. It was unexpectedly discovered that the present of one or more light stabilizers within the polymerized material near the surface could sufficiently promote adhesion to the mar resistant material so as to result in both excellent mar resistance as well as anti-weathering capabilities for continued clarity over time.

Processes as provided herein to form the mar resistant thermoplastic material include procedure(s) suitable for layering a mar resistant coating onto a surface. Optionally, a process includes providing a substrate comprising a thermoplastic material, combining a light stabilizer into the thermoplastic material by infusion into a surface of the thermoplastic material, or mixing into the thermoplastic material, or combinations thereof, so as to form a light stabilized surface, the light stabilizer penetrating the surface, and layering a mar resistant coating onto the light stabilized surface to produce a mar resistant thermoplastic material, wherein the mar resistant material is absent any composition between the light stabilized surface and the mar resistant coating that promotes adhesion of the mar resistant coating to the light stabilized surface and such that the mar resistant coating is directly on the light stabilized surface. The resulting material has both characteristics of excellent mar resistance as well as excellent anti-weathering properties. In some aspects, a light stabilized surface is subjected to a pre-treatment step to alter the surface of the thermoplastic material such as by increasing the available oxygen level on the surface available for bonding to the mar resistant material when layered thereon. In some aspects, the pre-treatment includes subjecting the light stabilized surface to a plasma comprising oxygen and optionally nitrogen prior to the step of layering.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals and in which:

FIG. 1 illustrates the expected concentration of UV absorber as a function of depth following infusion into polycarbonate (PC);

FIG. 2A illustrates water droplets on untreated PC;

FIG. 2B illustrates water droplets on plasma pre-treated treated PC;

FIG. 2C illustrates water droplets on light stabilizer infused PC;

FIG. 2D illustrates water droplets on light stabilizer infused then plasma pre-treated PC; and

FIG. 3 illustrates optical absorption measurements of light stabilizer infused PC before and after plasma pre-treatment using two different oxygen plasma powers for two different times and illustrating no significant difference in the ability of the material to absorb UV light whether plasma-pretreated or not.

### DETAILED DESCRIPTION

The following description of particular aspect(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the compositions and processes are described as an order of individual steps or using specific materials, it is appreciated that described steps or materials may be interchangeable such that the description of the invention includes multiple parts or steps arranged in many ways as is readily appreciated by one of skill in the art.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

The present disclosure provides mar resistant materials and processes useful for improving adherence of a mar resistant coating to an organic substrate such as polycarbonates, as one example, while simultaneously providing improved weatherability. The materials mar resistant materials have utility as materials for use in automotive surfaces such as a glass replacement, among many other uses. Although much of the disclosure is presented with respect to polycarbonate as an exemplary organic substrate, it is appreciated that many other organic materials illustratively but not limited to polyethylene terephthalate (PET), poly(methyl methacrylate) (PMMA), and acrylonitrile butadiene styrene (ABS), among others may also be used.

Processes for the formation of a mar resistant thermoplastic material having excellent weatherability are provided. The term “mar” as used herein is intended to mean scratch and mar as the term is traditionally used. The resulting thermoplastic materials achieve such properties optionally without the need for a primer layer between the underlying thermoplastic and a mar resistant coating that is a hallmark of prior systems. As such, in some aspects, an intermediate primer layer is absent between the organic substrate and the mar resistant coating. In addition, the materials are resistant to discoloration due to UV light by successfully infusing one or more light stabilizers into the outer surface of the substrate material optionally absent the presence of a light stabilizer dispersed throughout the organic substrate. It was unexpectedly discovered that the addition of a mar resistant coating with suitable adhesion did not require the addition of any type of adhesion promoter presented either as an intermediate primer layer or infused or otherwise localized into the thermoplastic substrate. Studies unexpectedly discovered that light stabilizers that provide or may be induced to provide a surface exposed oxygen alone produce excellent adhesion to a mar resistant coating without observable destruction of the weatherability provided by the presence of the UV light stabilizer. The resulting materials offer the necessary UV weatherability and mar resistance to be useful in many exterior applications such as transparent automotive surfaces, as one example, and do so without the need for significant processing or the presence of intermediate layers between a mar resistant layer and the substrate material.

A process includes combining a light stabilizer into the thermoplastic material such as by infusion directly into the surface or otherwise intermixing with the thermoplastic material to form a light stabilized surface, and then layering a mar resistant coating onto the light stabilized surface. A process optionally excludes the infusion or coating of any form of adhesion promoter such as the adhesion promoters described in application PCT/US2014/054717. A process optionally also excludes any primer layer between the light stabilized surface and the mar resistant coating such that the mar resistant coating is optionally directly on the light stabilized surface. According to the provided processes, a mar resistant coating material is thereby able to effectively adhere to the organic substrate and provide the necessary mar resistance while the infused light absorber is present to prevent discoloration or degradation, and unexpectedly, the surface exposed light absorber promoting additional adhesion to the mar resistant coating. The resulting materials for the first time provide both excellent mar resistance and weatherability.

In some aspects, a process includes infusing a light stabilizer into the surface of a thermoplastic so as to form a light stabilized surface. A light stabilizer is optionally a UV light absorber, a hindered-amine light stabilizers (HALS), or combinations thereof. The process of infusion optionally excludes a covalent interaction between an light stabilizer and a thermoplastic substrate. Optionally, an thermoplastic substrate is a solid, cured polymeric material prior to combination with the light stabilizer. An organic substrate is optionally a thermoplastic material. A thermoplastic material is optionally one or more of, polyethylene terephthalate (PET), polybutylene terephthalate (PBT), polycarbonates (PC), polylactic acid (PLA), nylon, PET copolymers, acrylics, SURLYN, polyethylene naphthalate (PEN), polyamides, polycarbonate co-polymers, elastomeric polymers—thermoplastic elastomers, thermoplastic urethanes, polyurethanes, acrylic co-polymers, poly(methyl methacrylate) (PMMA), acrylonitrile butadiene styrene (ABS), or other thermoplastics. In particular aspects, a thermoplastic is a polyolefin. In some aspects, a thermoplastic is a polycarbonate. Illustrative examples of a polycarbonate include those sold under the trade names LEXAN (combination of bisphenol A with phosgene), MAKROLON, or MAKROCLEAR, PANLITE, CALIBRE, TRIREX, among others.

For the preparation of polycarbonates for the compositions as provided herein, reference may be made, for example, to “Schnell”, Chemistry and Physics of Polycarbonates, Polymer Reviews, Vol. 9, Interscience Publishers, New York, London, Sydney 1964, to D. C. PREVORSEK, B. T. DEBONA and Y. KESTEN, Corporate Research Center, Allied Chemical Corporation, Moristown, N.J. 07960, “Synthesis of Poly(ester)carbonate Copolymers” in Journal of Polymer Science, Polymer Chemistry Edition, Vol. 19, 75-90 (1980), to D. Freitag, U. Grigo, P. R. Müller, N. Nouvertne, BAYER AG, “Polycarbonates” in Encyclopedia of Polymer Science and Engineering, Vol. 11, Second Edition, 1988, pages 648-718, and finally to Dres. U. Grigo, K. Kircher and P. R. Müller, “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299.

Some aspects include infusion of a light stabilizer into the outer surface of an organic substrate. As used herein, the term “light stabilizer” is meant to include molecules that have functionality of absorbing UV light, or scavenging free radicals. A UV absorber absorbs UV light changing the energy to heat that is dissipated through the material. A radical scavenger light stabilizer (e.g., a sterically hindered amine light scavenger (HALS)) chemically reacts with a free radical. A light stabilizer as used herein is optionally a UV absorber, a radical scavenger, or both. Optionally, a light stabilizer is not a radical scavenger.

Materials are provided that have a UV light stabilizer localized into one or more outer surfaces of an organic substrate. Without being limited to one particular theory, it is believed that the light stabilizer supplies sufficient reactive surface groups to allow a mar resistant coating to adhere with sufficient affinity to provide mar resistance to the resulting material. Further enhancement in mar resistant coating adherence is expected after the PC samples containing the infused light stabilizer are treated with a plasma to increase the number of anchor points on the surface. Without being limited to one particular theory, for naked or uninfused organic substrates, in the chemical vapor deposition of a mar resistant coating, the Si in the vapor phase bonds with the oxygen on the polymeric substrate to form an O—Si bond. In the case of SiNₓ coatings, the Si then reacts with a nitrogen atom in the vapor phase, resulting in a O—Si—N intermediate state that is strongly bound to the polymeric substrate and can bond strongly to the SiN_{X} hard coating. For these cases, the adhesion between the substrate and hard coating is determined by the density of the oxygen molecules at the surface. Increasing the density of oxygen or other desired reactive element (e.g. N, C, S, P, or any other active element or group that will interact with a hardcoat material) would increase the adhesion and, therefore, the scratch resistance of the hard coating. If the degree of oxidation is too great, however, the polymeric material may begin to break down and lose its desired properties. Once again, without being limited to one particular theory, the addition of the light stabilizer appears to increase the number of bonding sites compared to the bare substrate. A further increase is expected when the light stabilizer infused substrate is plasma pre-treated because, in general, plasma pre-treatment in the presence of oxygen will create a higher density of exposed oxygen groups.

A light stabilizer is optionally a UV absorber. A UV absorber absorbs UV light changing the energy to heat that is dissipated through the material. Illustrative examples of UV absorbers include a benzophenone, a benzotriazole, a hydrozyphenyltriazine, an oxalic anilide, or a combination thereof. Additional examples of UV absorbers are found in U.S. Pat. Nos. 5,559,163 and 8,044,122. Some aspects of this disclosure include the UV absorber TINUVIN 384-2 that is a mixture of C₇₋₉ ester of [3-2h-benzotriazol-2-yl)-5-(1,1-dimethylethyl)-4-hydroxyphenyl)]-propionic acid (herein tinuvin 384-2), TINUVIN 1130 (methyl 3-[3-(benzotriazol-2-yl)-5-tert-butyl-4-hydroxyphenyl]propanoate) (herein tinuvin 1130), UV531 (2-Hydroxy-4-octyloxybenzophenone), TINUVIN 928 (2-(2H-Benzotriazol-2-yl)-6-(1-methyl-1-phenylethyl)-4-(1,1,3,3-tetramethylbutyl)phenol), UV531 (2-Hydroxy-4-octyloxybenzophenone), UV416 (2-(4-Benzoyl-3-hydroxyphenoxy)ethyl acrylate), or any combination thereof.

A radical scavenger light stabilizer (e.g., a sterically hindered amine light scavenger (HALS)) chemically reacts with a free radical. Examples of a HALS include the ester derivatives of a decanedioic acid, such as a HALS I [bis(1,2,2,6,6-pentamethyl-4-poperidinyl)ester] and/or a HALS II [bis(2,2,6,6-tetramethyl-1-isooctyloxy-4-piperidinyl)ester].

A light stabilizer is infused into a substrate by any of several processes. In some aspects, a light stabilizer is infused into an organic substrate by the processes of U.S. Pat. Nos. 6,733,543; 6,749,646; 7,175,675; 7,504,054; 6,959,666; 6,949,127; 6,994,735; 7,094,263; 8,206,463; or 7,921,680. In some aspects, a light stabilizer is infused into an organic substrate as described in U.S. Patent Application Publication Nos.: 2008/0067124; 2009/0297830; or 2009/0089942.

A light stabilizer is infused into the surface of an organic substrate. An organic substrate is appreciated to optionally be pre-polymerized prior to infusion with the light stabilizer. A light stabilizer is dissolved in an infusion solvent such as a water/ethanol mix, or ethanol (others are operable). An infusion solvent is optionally an aqueous solution, or a solution of one or more organic solvents or solutes. In some aspects, an infusion solvent includes water, a light stabilizer, and optionally one or more additives such as a second or additional light stabilizer. An additive is illustratively one more surfactants or emulsifiers.

A light stabilizer is optionally dissolved into an infusion solvent at a concentration of 0.01% by weight to 0.4% by weight, optionally 0.02% to 0.4% by weight, optionally from 0.02% to 0.08% by weight. A light stabilizer, when present is optionally provided at a concentration of 0.01% to 1.2% by weight or any value or range therebetween, optionally 0.15% to 0.3% by weight.

An infusion solvent is optionally an aqueous solution wherein water is present in an amount of less than or equal to 98 percent by weight, optionally less than or equal to 80 percent by weight, optionally less than or equal to 75 percent by weight. In some aspects, water is present in an infusion solvent in an amount of at least 50 or 51 percent by weight, optionally at least 60 percent by weight, and optionally at least 65 percent by weight. Water may be present in the infusion solvent in an amount ranging from 50 to 85 percent by weight or any value or range therebetween, with particular ranges being preferred. For example, water may be present in the infusion solvent in an amount from 50 (or 51) to 85 percent by weight, optionally 60 to 87 percent by weight, optionally in an amount of from 65 to 75 percent by weight, optionally 70 percent by weight. In some aspects, water is present from 85 to 99 percent by weight, optionally 90 to 98 percent, optionally 95 to 98 percent by weight, optionally 98 percent by weight. The percent weights being based on the total weight of the infusion solvent. The water used is optionally deionized water or distilled water the preparation of each of which is well known in the art.

An infusion solvent optionally includes one or more emulsifiers. Illustrative examples of an emulsifier include ionic or non-ionic emulsifiers, or mixtures thereof. Illustrative examples of an anionic emulsifier include: amine salts or alkali salts of carboxylic, sulfamic or phosphoric acids, for example, sodium lauryl sulfate, ammonium lauryl sulfate, lignosulfonic acid salts, ethylene diamine tetra acetic acid (EDTA) sodium salts, and acid salts of amines, such as, laurylamine hydrochloride or poly(oxy-1,2-ethanediyl), α-sulfo-omega-hydroxy ether with phenol 1-(methylphenyl)ethyl derivative ammonium salts. An emulsifier is optionally an amphoteric emulsifier illustratively: lauryl sulfobetaine; dihydroxy ethylalkyl betaine; amido betaine based on coconut acids; disodium N-lauryl amino propionate; or the sodium salts of dicarboxylic acid coconut derivatives. Typical non-ionic emulsifiers include ethoxylated or propoxylated alkyl or aryl phenolic compounds, such as octylphenoxypolyethyleneoxyethanol. A specific illustrative emulsifier used is diethylene glycol.

An emulsifier is optionally present in an infusion solvent in an amount from 0 to 15 weight percent, optionally 7 to 15 weight percent, optionally 10 to 15 weight percent.

An infusion solvent optionally includes an infusion agent. An infusion agent is optionally a compound having the formula of Formula I:

R¹[(O(CH₂)ₘ)ₙ]OR² (I)

where wherein R² and R¹ are each independently H or a C₁₋₁₈ alkyl radical, benzyl radical, benzoyl radical, or phenyl radical; n is 1, 2 or 3; and m is any value from 1 to 35. In some aspects, m is 1 to 12. In some aspects, m is 1. Optionally, R² denotes butyl and R¹ denotes H. An aromatic R¹ or R² group of Formula I is optionally substituted with 1 to 5 groups selected from halo groups (e.g., chloro, bromo and fluoro), linear or branched C₁-C₉ alkyl groups (e.g., methyl, ethyl, propyl, butyl, pentyl, hexyl, heptyl, octyl and nonyl), and aromatic groups (e.g., phenyl). In illustrative aspects, an infusion agent is 2-butoxyethanol.

A substrate is heated to an infusion temperature. An infusion temperature is below the melting temperature of the organic substrate material but sufficient to soften the material without stressing the material configuration (e.g. shape). An infusion temperature is optionally from 60° C. to 98° C., or any value or range therebetween. Optionally, an infusion temperature is 95° C. for PC and 70° C. for less heat stable polymers. Optionally, an infusion solvent is preheated or heated in the presence of an organic substrate, optionally to any infusion temperature less than 100° C. Optionally, an infusion temperature is between 70° C. and 95° C.

A process for forming a light stabilizer infused organic substrate optionally includes mixing a thermoplastic material with an infusion solvent containing a light stabilizer for an infusion time. Mixing is optionally immersing an organic substrate material in an infusion solvent, spraying an infusion solvent on a colored thermoplastic, or other mixing recognized by one of skill in the art. An infusion time is optionally any time from 1 minute to 120 minutes, or more. In particular aspects, an infusion time is optionally from 1 second to 30 minutes, optionally from 1 second to 20 minutes, optionally from 1 second to 10 minutes, optionally from 10 seconds to 3 minutes. An infusion time is optionally 1, 2, 3, 4, 5, 6, 7, 8, 9, 10, 20, 30, 40, 50, seconds, or 1, 2, 3, 4, 5, 6, 7, 8, 9, 10, 15, 20, 25, or 30 minutes. As one illustrative example, an infusion time for polycarbonate may be 1 to 10 minutes.

Following infusion, an infused substrate is optionally washed, dried, etc. Washing is optionally performed by a cold solvent rinse followed by a water rinse. Optionally, a water rinse is use without a cold-solvent rinse. The substrate is optionally dried by forced air, optionally heated forced air, gently wiped, or air dried.

A light stabilizer is infused into the surface of an organic substrate optionally to a depth of less than 1 millimeter (mm), optionally less than 200 micrometers (μm), optionally to about 150 to 250 μm. Optionally, a light stabilizer is not present in a thermoplastic material to a depth any greater than 1 mm, optionally 200 μm. Optionally, a light stabilizer penetrates a surface of the thermoplastic material in a gradient where less light stabilizer by weight is present as the depth of the thermoplastic material increases. Optionally, a light stabilizer does not penetrate the entire depth of the thermoplastic material.

Following infusion of a light stabilizer into the surface of the organic substrate, one or more hardcoats and/or mar resistant coatings are optionally applied to the light stabilized surface. Unlike prior systems that required a primer material between the organic substrate and the hardcoat to promote adequate adhesion between the two, direct association between the organic substrate and one or more hardcoat or mar resistant layers is provided by processes as disclosed herein. The use of a light stabilizer optionally negates the need of a primer allowing direct application of the hardcoat to the organic substrate surface as is traditionally required for adequate performance. As such, a mar resistant organic material optionally excludes a primer layer between the organic substrate and a hardcoat layer. Also, the use of light stabilizers that either present exposed oxygen or are oxidizable by plasma treatment to expose reactive oxygen negates the need for the addition of adhesion promoters.

In some aspects, one or more hardcoat layers are coated onto a light stabilizer infused organic substrate. Illustrative examples of hardcoat on organic polymeric materials optionally include those hardcoat materials described in U.S. Patent Application Publication No: 2006/0147674, or U.S. Pat. No. 8,216,679 or 8,361,607. Specific examples of mar resistant materials include polymerization curable monomers/oligomers resins or sol-gel glass. A mar resistant material is optionally α-siloxane, a silicon nitride, a silicon oxycarbide, an organic modified silicon, or combinations thereof. Additional examples of a mar resistant material used in a hardcoat layer include an organo-silicon, an acrylic, a urethane, a melamine, SiOₓ, SiNₓ, SiOₓN_{y} (silicon oxynitrides), or an amorphous SiOₓC_{y}H_{z} where the letters x, y, and z in any of the foregoing are art recognized materials. Optionally, a mar resistant material layer includes resins include acrylic resins, urethane resins, epoxy resin, phenol resin, and polyvinylalcohol. In some aspects, the mar resistant coating materials includes dipentaerythritol pentaacrylate (available, for example, under the trade designation “SR399” from Sartomer Company, Exton, Pa.), pentaerythritol triacrylate isophorondiisocyanate (IPDI) (available, for example, under the trade designation “UX5000” from Nippon Kayaku Co., Ltd., Tokyo, Japan), urethane acrylate (available, for example, under the trade designations “UV 1700B” from Nippon Synthetic Chemical Industry Co., Ltd., Osaka, Japan; and “UB6300B” from Nippon Synthetic Chemical Industry Co., Ltd., Osaka, Japan), trimethyl hydroxyl di-isocyanate/hydroxy ethyl acrylate (TMHDI/HEA, available, for example, under the trade designation “EB4858” from Daicel Cytech Company Ltd., Tokyo, Japan), polyethylene oxide (PEO) modified bis-A diacrylate (available, for example, under the trade designation “R551” from Nippon Kayaku Co., Ltd., Tokyo, Japan), PEO modified bis-A epoxyacrylate (available, for example, under the trade designation “3002M” from Kyoeishi Chemical Co., Ltd., Osaka, Japan), silane based UV curable resin (available, for example, under the trade designation “SK501M” from Nagase ChemteX Corporation, Osaka, Japan), and 2-phenoxyethyl methacrylate (available, for example, under the trade designation “SR340” from Sartomer Company); and the mixture of thereof. In some aspects, use of di-functional resins (e.g., PEO modified bis-A diacrylate (“R551”) and trimethyl hydroxyl di-isocyanate/hydroxy ethyl acrylate (TMHDI/HEA) (available, for example, under the trade designation “EB4858” from Daicel Cytech Company Ltd.) may improve the hardness, impact resistance, and flexibility of the hardcoat. In some aspects, it may be desirable to use curable monomers or oligomers capable of forming three-dimensional structure.

Optionally, the hardcoat further comprises crosslinking agents. Exemplary crosslinking agents include poly(meth)acryl monomers selected from the group consisting of (a) di(meth)acryl containing compounds such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, tripropylene glycol diacrylate; (b) tri(meth)acryl containing compounds such as glycerol triacrylate, trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, tris(2-hydroxyethyl)isocyanurate triacrylate; (c) higher functionality (meth)acryl containing compounds such as ditrimethylolpropane tetraacrylate, dipentaerythritol pentaacrylate, ethoxylated (4) pentaerythritol tetraacrylate, pentaerythritol tetraacrylate, caprolactone modified dipentaerythritol hexaacrylate; (d) oligomeric (meth)acryl compounds such as, for example, urethane acrylates, polyester acrylates, epoxy acrylates; polyacrylamide analogues of the foregoing; and combinations thereof. Such materials are commercially available, including at least some that are available, for example, from Sartomer Company; UCB Chemicals Corporation, Smyrna, Ga.; and Aldrich Chemical Company, Milwaukee, Wis. Other useful (meth)acrylate materials include hydantoin moiety-containing poly(meth)acrylates, for example, as reported in U.S. Pat. No. 4,262,072 (Wendling et al.).

In some aspects a crosslinking agent includes at least three (meth)acrylate functional groups. Commercially available crosslinking agents illustratively include those available from Sartomer Company such as trimethylolpropane triacrylate (TMPTA) (available under the trade designation “SR351”), pentaerythritol tri/tetraacrylate (PETA) (available under the trade designations “SR444” and “SR295”), and pentraerythritol pentaacrylate (available under the trade designation “SR399”). Further, mixtures of multifunctional and lower functional acrylates, such as a mixture of PETA and phenoxyethyl acrylate (PEA), available from Sartomer Company under the trade designation “SR399”, may also be utilized. Crosslinking agents may be used as the curable monomers or oligomers.

A mar resistant material layer optionally includes one or more inorganic materials, illustratively, alumina, tin oxides, antimony oxides, silica (SiO, SiO₂), zirconia, titania, ferrite, mixtures thereof, or mixed oxides thereof; metal vanadates, metal tungstates, metal phosphates, metal nitrates, metal sulphates, or metal carbides.

The mar resistant coating layer may be extruded or cast as thin films or applied as a discrete coating. Optionally, a mar resistant coating layer is applied by dip coating, flow coating, spray coating, curtain coating, or other techniques known to those skilled in the art. A variety of additives may be added to the hardcoat such as colorants (tints), rheological control agents, mold release agents, antioxidants, ultraviolet absorbing (UVA) molecules, and IR absorbing or reflecting pigments, among others.

Aspects of the coated organic substrates include a mar resistant coating that optionally includes or is free of a polymeric material, the mar resistant coating either layered upon a hardcoat layer or applied directly on the surface of the light stabilized surface of the substrate. Illustrative examples of mar resistant coatings include but are not limited to of such organo-silicon materials include trialkoxysilanes or triacyloxysilanes such as methyltrimethoxysilane, methyltriethoxysilane, methyltrimethoxyethoxysilane, methyltriacetoxysilane, methyltripropoxysilane, methyltributoxysilane, ethyltrimethoxysilane, ethyltriethoxysilane, vinyltrimethoxysilane, vinyltriethoxysilane, vinyltracetoxysilane, vinyltrimethoxyethoxysilane, phenyltrimethoxysilane, phenyltriethoxysilane, phenyltriacetoxysilane, gamma-chloropropyltrimethoxysilane, gamma-chloropropyltriethoxysilane, gamma-chloropropyltripropoxysilane, 3,3,3-trifluoropropyltrimethoxysilane gamma-glycidoxypropyltrimethoxysilane, gamma-glycidoxypropyltriethoxysilane, gamma-(beta-glycidoxyethoxy)propyltrimethoxysilane, beta-(3,4-epoxycyclohexyl)ethyltrimethoxysilane, beta-(3,4-epoxycyclohexyl)ethyltriethoxysilane, gamma-methacryloxypropyltrimethyoxysilane, gamma-aminopropyltrimethoxysilane, gamma-aminopropyltriethoxysilane, gamma-meraptopropyltrimethoxysilane, gamma-mercaptopropyltriethoxysilane, N-beta(aminoethyl)-gamma-aminopropyltrimethoxysilane, beta-cyanoethyltriethoxysilane and the like; as well as dialkoxysilanes or diacyloxysilanes such as dimethyldimethoxysilane, phenylmethyldimethoxysilane, dimethyldiethoxysilane, phenylmethyldiethoxysilane, gamma-glycidoxypropylmethyldimethoxysilane, gamma-glycidoxypropylmethyldiethoxysilane, gamma-glycidoxypropylphenyldimethoxysilane, gamma-glycidoxypropylphenyldiethoxysilane, gamma-chloropropylmethyldimethoxysilane, gamma-chloropropylmethyldiethoxysilane, dimethyldiacetoxysilane, gamma-methacryloxypropylmethyldimethoxysilane, gamma-metacryloxypropylmethyldiethoxysilane, gamma-mercaptopropylmethyldimethoxysilane, gamma-mercaptopropylmethyldiethoxysilane, gamma-aminopropylmethyldimethoxysilane, gamma-aminopropylmethyldiethoxysilane, methylvinyldimethoxysilane, methylvinyldiethoxysilane and the like.

A mar resistant layer optionally includes or is exclusively one or more inorganic materials, illustratively, alumina, tin oxides, antimony oxides, silica (SiO, SiO₂), zirconia, titania, ferrite, mixtures thereof, or mixed oxides thereof; metal vanadates, metal tungstates, metal phosphates, metal nitrates, metal sulphates, or metal carbides.

The mar resistant layers may be coated onto the substrate by dip coating in liquid followed by solvent evaporation, or by chemical vapor deposition, such as plasma enhanced chemical vapor deposition, optionally via a suitable monomer or other precursor. Alternative deposition techniques such as flow coating and spray coating are also suitable. To improve the abrasion resistance of the hardcoating, subsequent coatings of the mar resistant layer may be added, preferably within a 48 hour period to as to avoid aging and contamination of the earlier coatings.

The addition of a glass-like mar-resistant coating or hardcoat onto an infused organic substrate may be achieved by one of many processes including: Plasma Enhanced Chemical Vapor Deposition (PECVD) which provides an extremely hard, scratch resistant surface; sputtering technologies; and evaporation. PECVD methodologies are reviewed by Gilliam, M. A. and Gasworth, S., Proceedings of Society of Vacuum Coaters Annual Conference, Chicago, Ill., USA, 19-24 Apr. 2008; and Seuber et al., Coatings, 2012; 2:221-234. Additional a methodologies may be found in Park and Rhee, Surface and Coatings Technology 2004; 179: 229-236.

The reactive reagent for the PECVD process may include a volatile organosilicon compound that is illustratively, but is not limited to octamethylcyclotetrasiloxane (D4), tetramethyldisiloxane (TMDSO), hexamethyldisiloxane (HMDSO), silicon nitrides (SiNₓ), or another volatile organosilicon compound. PECVD processes of depositing SiNₓ or other silicon containing materials onto substrates can be found illustratively in Abdallah, et al., Surface and Coatings Technology, Vol. 204(2009), No. 1-2, p. 78-84, T. Schmauder, et al., Thin Solid Films, vol. 502, pp. 270-274, Apr. 28, 2006, as well as being well understood in the art. The organosilicon compounds are oxidized, decomposed, and polymerized in the arc plasma deposition equipment, typically in the presence of oxygen and an inert carrier gas, such as argon, to form a mar resistant layer. In some aspects, the composition of the resulting mar resistant layer may vary from SiOₓ to SiOₓC_{y}H_{z} where x, y, and z vary depending on the specific organosilicon material used. Other illustrative materials suitable for the mar resistant layer include silicon monoxide, silicon dioxide, silicon oxycarbide, and hydrogenated silicon oxycarbide, among others, as well as mixtures thereof.

In some aspects a light stabilized surface is subjected to a pre-treatment process whereby the surface is oxidized or otherwise modified relative to prior to the pre-treatment process. Optionally, a light stabilized surface is subjected to a plasma created from a gas optionally containing oxygen. Optionally, the gas contains oxygen and nitrogen. Plasma pre-treatment is optionally performed at a substrate temperature of 15° C. to 30° C., or any value or range therebetween. Optionally, a substrate temperature is at or about 17° C. to 25° C., optionally at or about 25° C. Optionally, the pre-treatment is performed at a gas temperature of 15° C. to 30° C., or any value or range therebetween. Optionally, a gas temperature is at or about 17° C. to 25° C., optionally at or about 25° C. In some aspects, a plasma pre-treatment time is sufficient to treat part or the entire light stabilized surface where treatment time is dependent on the desired area of pre-treatment. For a single area suitably sized for the pre-treatment apparatus, a treatment time is optionally from 5 seconds to 20 seconds, or any value or range therebetween. Optionally, a treatment time is 5 seconds to 15 seconds, optionally about 10 seconds. If the size of the substrate being treated is larger than the treatable area by the apparatus, moving the substrate or the apparatus may be performed and treatment time repeated until the entire desired area of the thermoplastic material is treated.

The resulting coated substrates have excellent scratch resistance. Scratch resistance for automotive hardcoat applications is governed by a Federal Motor Vehicle Safety Standard [Federal Motor Vehicle Safety Standard 205; US Department of Transportation: Washington, D.C., USA, 2006] and accompanying test method [Abrasion Resistance; American National Standard for Safety Glazing Materials for Glazing Motor Vehicles and Motor Vehicle Equipment Operating on Land Highways—Safety Standard, Tests 17 and 18; SAE: Warrendale, Pa., USA, 1997], or as tested by Taber Abraser (Abrader) with the protocol available online at http://www.taberindustries.com/taber-rotary-abraser (last accessed on 9 Sep. 2014). Such testing procedures and the requirements for such materials are discussed by Seubert et al., Coatings, 2012; 2, 221-234; doi:10.3390/coatings2040221.

Various aspects of the present disclosure are illustrated by the following non-limiting examples. The examples are for illustrative purposes and are not a limitation on any practice of the present invention. It will be understood that variations and modifications can be made without departing from the spirit and scope of the invention. Reagents illustrated herein are commonly commercially available, and a person of ordinary skill in the art readily understands where such reagents may be obtained.

### Experimental

Infusion of Light Stabilizer Material into PC.

10 mil extruded polycarbonate DE1-1 film from Sheffield (extruded from Bayer's Makrolon 2608) is infused with 2-hydroxy-4-n-octoxybenzophenone (UV 531, Cytec Industries). For infusion, an infusion solvent including water (70% w/w), infusion agent (2-butoxyethanol) (20% w/w) and emulsifier (diethylene glycol) (10% w/w) containing the 2-hydroxy-4-n-octoxybenzophenone is heated to a temperature of 96° C. Both cold and very hot PC materials are treated in individual batches. For different infusions, infusion time can range while submersed in the infusion solvent for 1, 5, 8, 10, 20, or 30 seconds.

Following the infusion time, the test samples are rinsed twice in water to remove residual infusion agent solution and then allowed to dry at room temperature overnight.

Plaques are divided into four groups for subsequent testing: 1) polycarbonate that is not infused with UV agent, but is to be layered with hardcoating directly on the surface of the plastic; 2) polycarbonate that is subjected to a plasma-pretreatment and then subjected to a hard-coating; 3) polycarbonate that is infused with 2-hydroxy-4-n-octoxybenzophenone as per above; and 4) polycarbonate that is infused with 2-hydroxy-4-n-octoxybenzophenone as per above, subjected to a plasma-pretreatment and then hardcoated.

For plaques that are subjected to a plasma pre-treatment, the plaques were placed in an Enercon Dyne-A-Mite 3D Treater with a 15 kV power supply, a blower, and a plasma head with a plasma jet approximately 2 inches long×½ inch wide that extends approximately 1 out of the head. Gas for plasma pretreatment was ionized nitrogen and oxygen. The PC or PC+UV infused substrates were individually placed approximately 1 inch below the plasma head on a translation stage with the 2 inch width of the substrate aligned with the 2 inch width of the plasma. The plasma head was turned on, and the samples were translated under the plasma at a rate of 0.25 inch/second until the entire plaque was treated. This process was repeated for a total of 4 passes.

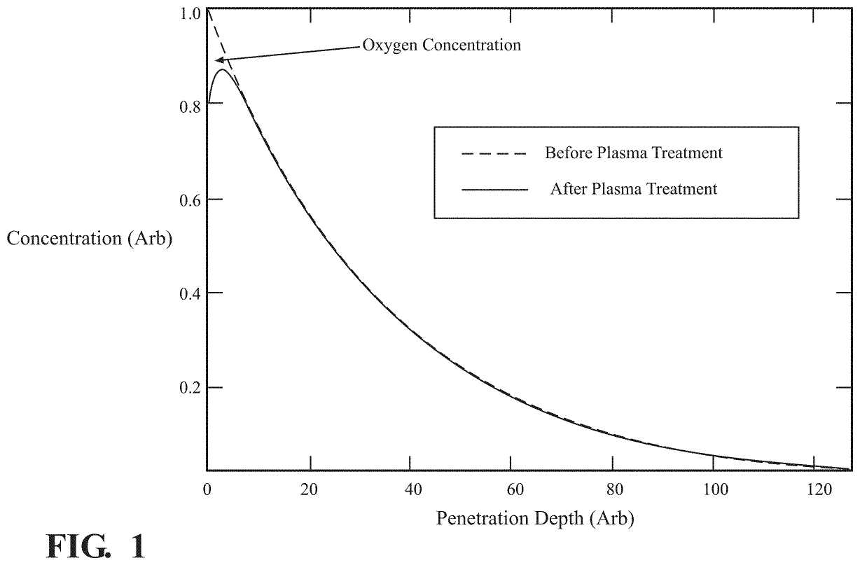

FIG. 1 is a schematic graph of how the concentration of the UV absorbing molecule may vary as a function of depth into the substrate before and after plasma treatment. The difference in the curves before and after oxygen plasma treatment is representative of an increase oxygen group concentration at the surface. It is believed that these groups provide additional anchoring points for subsequent integration of the hardcoat.

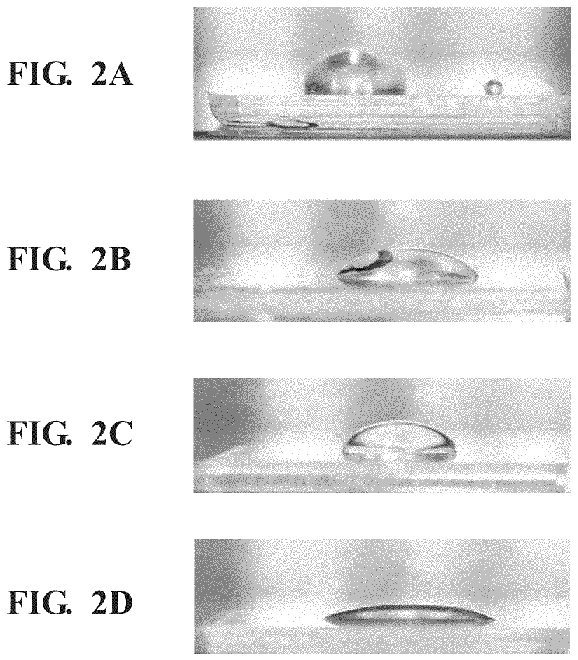

Plasma pretreatment treatment efficacy was determined by observing the contact angle of a water droplet on the substrate. FIG. 2 shows photos of water droplets on PC samples with four treatments: A) untreated; B) plasma treated; C) light stabilizer infused as per above; and D) light stabilizer infused as per above with plasma treatment. The contact angle of the water droplet indicates the number of oxygen groups exposed at the surface as described in T. N. Chen, D. S. Wuu, C. C. Wu, C. C. Chiang, H. B. Lin, Y. P. Chen, et al., “Effects of plasma pretreatment on silicon nitride barrier films on polycarbonate substrates,” Thin Solid Films, vol. 514, pp. 188-192, Aug. 30, 2006. Interestingly, there is little difference between the untreated and light stabilizer infused samples (FIGS. 2A and C) indicating no detectable significant difference in the surface concentration of oxygen groups. Plasma pre-treatment does increase the number of oxygen atoms at the surface for both untreated and light stabilizer infused samples (compare panels A and B, and panels C and, respectively) but overally a significant difference in the contact angle is seen when the PC is infused with light stabilizer and subsequently plasma treated. (FIG. 2D) This experiment indicates that the number of exposed oxygen atoms is the highest with the light stabilizer infused and plasma pre-treated sample.

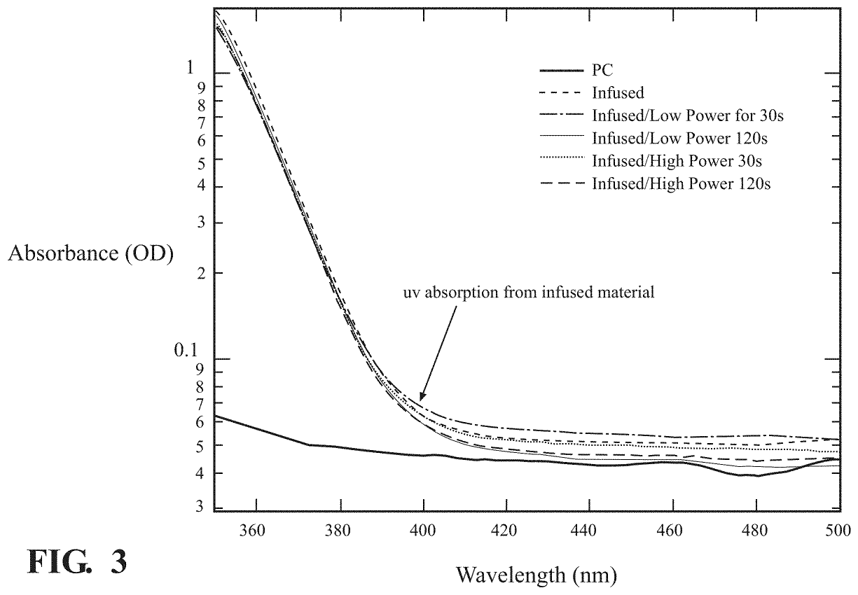

Without being bound to one particular theory, it is believed that on a naked organic polycarbonate substrate oxygen groups are exposed because the plasma treatment removes carbon atoms from the substrate. When the light stabilizer is present, the increase in surface oxygen might be accompanied by a loss in UV protection. To determine if this is the case, the absorption spectrum of the samples was measured before and after plasma treatment. FIG. 3 shows the optical absorption spectra. There is no significant difference between the infused sample before and after plasma pre-treatment. Taken together, FIGS. 2 and 3 suggest that some of the UV absorbing molecules may be modified leaving a higher density of oxygen atoms at the surface, but a vast majority of the molecules are unaltered and continue to provide UV protection.

It should be noted that the oxygen atom density at the surface may be increased by simple addition of oxygen gas during the deposition. This would improve the adhesion of the hard coating, but it would not alter the UV protection. This deposition method, with the addition of oxygen during deposition, used with a light stabilizer infused PC substrate may be more economical than deposition without oxygen on a plasma treated, light stabilizer infused PC substrate.

### Hard-Coating Samples

An Enercon Dyne-A-Mite 3D Treater installed in a vacuum chamber was used for hardcoat material deposition. In the test device, the power supply and head of the 3D Treater were used, but the blower was replaced with a gas line connected (outside the chamber) to silane (SiH₄) and ammonia (NH₃) sources. For depositions, the head was configured such that the 2 inch wide plasma was aligned with the 3 inch dimension of the test plaques. This resulted in a thick film in the middle of the plaque with a thickness gradient towards the edges.

Plaques were mounted to a heated substrate holder and loaded approximately 1.5 inches from the plasma head. The vacuum chamber was evacuated and the substrate temperature was set to 75° C. The system was allowed to sit for one hour before deposition. After the hour, the temperature was stable at 75° C. and the pressure was approximately 1e−5 Torr.

For silicon nitride (SiNₓ) hard coating depositions, the turbo pump valve was closed and a process pump valve was completely opened. The flow rates of SiH₄ and NH₃ were set to 2 standard cubic centimeters per second (sccm) and 40 sccm, respectively, and the pressure was allowed to stabilize at 210 mTorr. Once the pressure was stabilized, the plasma head was turned on and deposition started. The deposition lasted 40 minutes, at which point, the plasma head and heater were turned off.

Scratch tests were performed on the hard coated samples (untreated, plasma treated, UV infused, UV infused with plasma treatment) after SiNₓ hard coating deposition using a 1 mm hemispherical scratch tip as per standard procedures. Table 1 shows the results of the scratch testing using a 1 mm hemispherical head and three forces using the ASTM standard test D7027 and/or G171. This is a standard test for the automobile industry.

TABLE 1
Scratch testing results for untreated PC, plasma pre-treated
PC, light stabilizer infused PC, and light stabilizer infused
then plasma pre-treated PC. “No” indicates no scratch;
“Deep” is a deep scratch; “Light” is a light scratch.

| | 3N | 6N | 10N |
|---|---|---|---|
| Untreated | No | No | Deep |
| Plasma Treated | No | No | Deep |
| UV infused | No | No | Light |
| UV infused then plasma | No | No | Light |

As seen in the table, all the samples provide scratch resistance to 3 N and 6 N, but significant improvements are observed with plaques that are infused with a light stabilizer as above which provides resistance to scratching at 10 N. This demonstrates the scratch resistance of the light stabilizer infused samples.

Additional plaques are coated with different hardcoat materials. Plaques that were either light stabilizer infused or not, and plasma-pretreated or not as above, were subjected to hardcoat materials of dimethyl phenyl silanol, methyl phenyl silane, A-137 (monomeric alkylalkoxysilane from Silquest), and A-1128 (benzylamino-silane also from Silquest). Similar results are observed relative to the SiNₓ hardcoat materials where the presence of the light stabilizer resulted in improved scratch resistance.

### REFERENCE LIST

[1] D. K. Hwang, J. H. Moon, Y. G. Shul, K. T. Jung, D. H. Kim, and D. W. Lee, “Scratch resistant and transparent UV-protective coating on polycarbonate,” Journal of Sol-Gel Science and Technology, vol. 26, pp. 783-787, January 2003.
[2] Y. S. Lin, Y. H. Liao, and M. S. Weng, “Enhanced scratch resistance of polycarbonate by low temperature plasma-polymerized organosilica,” Thin Solid Films, vol. 517, pp. 5224-5230, July 2009.
[3] T. Schmauder, K. D. Nauenburg, K. Kruse, and G. Ickes, “Hard coatings by plasma CVD on polycarbonate for automotive and optical applications,” Thin Solid Films, vol. 502, pp. 270-274, Apr. 28, 2006.
[4] T. N. Chen, D. S. Wuu, C. C. Wu, C. C. Chiang, Y. P. Chen, and R. H. Horng, “High-performance transparent barrier films of SiOₓ/SiNₓ stacks on flexible polymer substrates,” Journal of the Electrochemical Society, vol. 153, pp. F244-F248, 2006 2006.
[5] T. N. Chen, D. S. Wuu, C. C. Wu, C. C. Chiang, H. B. Lin, Y. P. Chen, et al., “Effects of plasma pretreatment on silicon nitride barrier films on polycarbonate substrates,” Thin Solid Films, vol. 514, pp. 188-192, Aug. 30, 2006.
[6] S. M. Kang, S. G. Yoon, and D. H. Yoon, “Surface treatment of polycarbonate and polyethersulphone for SiNₓ thin film deposition,” Thin Solid Films, vol. 516, pp. 1405-1409, February 2008.
[7] T. Satoh and S. Takahashi, “IMPROVEMENT OF ADHESION BETWEEN SI3N4 THIN-FILMS AND POLYCARBONATE SUBSTRATES BY PREPARATION OF AN INTERPENETRATING LAYER USING MICROWAVE PLASMA ENHANCED CHEMICAL VAPOR-DEPOSITION,” Journal of Vacuum Science &Technology B, vol. 9, pp. 1540-1544, May-June 1991.
[8] K. Higuchi, M. Gilliam, and M. Yamaya, “Organic resin laminate,” U.S. Pat. No. 8,361,607 B2, 2013.
[9] K. Higuchi and H. Komori, “UV-shielding silicone coating composition and coated article,” U.S. Pat. No. 8,546,484 B2, 2013.
[10] M. Chen, S. M. Gasworth, S. Grandhee, and J. R. Sargent, “Glazing system for vehicle tops and windows,” U.S. Pat. No. 8,216,679 B2, 2012.
[11] T. Crouch and R. F. Sieloff, “Process for hardcoating polycarbonate sheet,” EP0371413 B1, 1995.
[12] C. Lefaux, N. Menon, K. Stellmach, S. K. Grandhee, K. D. Weiss, and K. Foster, “Plastic glazing panel having UV curable printed pattern and process for making the same,” U.S. Pat. No. 8,361,601 B2, 2013.

Various modifications of the present invention, in addition to those shown and described herein, will be apparent to those skilled in the art of the above description. Such modifications are also intended to fall within the scope of the appended claims.

It is appreciated that all reagents are obtainable by sources known in the art unless otherwise specified.

Patents, patent applications, and publications mentioned in the specification are indicative of the levels of those skilled in the art to which the invention pertains. These patents, applications, and publications are incorporated herein by reference to the same extent as if each individual application or publication was specifically and individually incorporated herein by reference.

1. A process of forming a mar resistant thermoplastic material comprising:
providing a substrate comprising a thermoplastic material;
combining a light stabilizer into the thermoplastic material by infusion into a surface of the thermoplastic material, or mixing into said thermoplastic material, or combinations thereof, so as to form a light stabilized surface, the light stabilizer penetrating the surface; and
layering a mar resistant coating onto the light stabilized surface to produce a mar resistant thermoplastic material, wherein the mar resistant material is absent any composition between the light stabilized surface and the mar resistant coating that promotes adhesion of the mar resistant coating to the light stabilized surface and such that the mar resistant coating is directly on the light stabilized surface.

2. The process of claim 1 wherein the mar resistant thermoplastic material is absent an adhesion promoter infused into the surface of the thermoplastic material, optionally absent an adhesion promoter coated onto the surface of the thermoplastic material.

3. The process of claim 1 wherein said substrate is polymerized prior to said step of combining.

4. The process of claim 1 wherein the step of combining is by infusing the light stabilizer into the surface of the substrate.

5. The process of any one of claims 1-4 wherein said substrate comprises a polycarbonate, polyethylene terephthalate (PET), polybutylene terephthalate (PBT), polycarbonate (PC), polylactic acid (PLA), nylon, PET copolymers, acrylics, SURLYN, polyethylene naphthalate (PEN), polyamides, polycarbonate co-polymers, elastomeric polymers—thermoplastic elastomers, thermoplastic urethanes, polyurethanes, acrylic co-polymers, poly(methyl methacrylate) (PMMA), acrylonitrile butadiene styrene (ABS), or other thermoplastic.

6. The process of any one of claims 1-4 further comprising subjecting the light stabilized surface to a plasma comprising oxygen and nitrogen prior to the step of layering.

7. The process of any one of claims 1-4 wherein the light stabilizer is a sterically hindered amine or a UV absorber.

8. The process of claim 7 wherein the light stabilizer is UV absorber, the UV absorber selected from the group consisting of a benzophenone, a benzotriazole, a hydroxyphenyltriazine, and an oxalic anilide.

9. The process of claim 7 wherein the UV absorber is selected from the group consisting of tinuvin 384-2, tinuvin 328, tinuvin 1130, tinuvin 928, tinuvin 1130, UV531, or UV416.

10. The process of claim 7 wherein the light stabilizer is a sterically hindered amine.

11. The process of claim 10 wherein the sterically hindered amine is a decanedioic acid derivative.

12. The process of any one of claims 1-4 wherein the light stabilizer penetrates the surface of the thermoplastic material to a depth of less than 1 millimeter.

13. The process of any of claims 1-4, wherein the light stabilizer penetrates the surface of the thermoplastic material to a depth of less than 200 micrometers.

14. The process of any one of claims 1-4 wherein the step of layering comprises depositing the mar resistant material by vacuum deposition.

15. The process of any one of claims 1-4 wherein said mar resistant material comprises, optionally consists of, an α-siloxane, a silicon nitride, a silicon oxycarbide, an organic modified silicon, or combinations thereof.

16. The process of any one of claims 1-4 wherein the mar resistant material comprises, optionally consists of, SiOₓ, Si₃N₄, SiC or other organosilicon compound, or combinations thereof.

17. A mar resistant thermoplastic material comprising:
a polymerized thermoplastic substrate, the substrate comprising a surface,
a light stabilizer within the thermoplastic substrate; and
a mar resistant material coated on, optionally directly on, the surface;
wherein the mar resistant thermoplastic material is absent any composition between the surface and the mar resistant material that promotes adhesion of the mar resistant material to the surface.

18. The mar resistant thermoplastic material of claim 17 absent an adhesion promoter infused into the surface of the thermoplastic material or coated onto the surface of the thermoplastic material.

19. The mar resistant thermoplastic material of claim 17 wherein the light stabilizer is infused into the surface of the substrate.

20. The mar resistant thermoplastic material of claim 17 wherein the light stabilizer penetrates the surface of the thermoplastic material to a depth of less than 1 millimeter.

21. The mar resistant thermoplastic material of claim 17 wherein the light stabilizer penetrates the surface of the thermoplastic material to a depth of less than 200 micrometers.

22. The mar resistant thermoplastic material of any one of claims 17-21 wherein said thermoplastic comprises polyethylene terephthalate (PET), polybutylene terephthalate (PBT), polycarbonates (PC), polylactic acid (PLA), nylon, PET copolymers, acrylics, SURLYN, polyethylene naphthalate (PEN), polyamides, polycarbonate co-polymers, elastomeric polymers—thermoplastic elastomers, thermoplastic urethanes, polyurethanes, acrylic co-polymers, poly(methyl methacrylate) (PMMA), acrylonitrile butadiene styrene (ABS), or other thermoplastic.

23. The mar resistant thermoplastic material of any one of claims 17-21 wherein said thermoplastic comprises a polycarbonate.

24. The mar resistant thermoplastic material of any one of claims 17-21 wherein the light stabilizer is UV absorber, the UV absorber selected from the group consisting of a benzophenone, a benzotriazole, a hydroxyphenyltriazine, and an oxalic anilide.

25. The mar resistant thermoplastic material of claim 24 wherein UV absorber is selected from the group consisting of tinuvin 384-2, tinuvin 328, tinuvin 928, tinuvin 1130, UV531, or UV416.

26. The mar resistant thermoplastic material of any one of claims 17-21 wherein the light stabilizer is a sterically hindered amine.

27. The mar resistant thermoplastic material of claim 26 wherein the sterically hindered amine is decanedioic acid derivative.

28. The mar resistant thermoplastic material of any one of claims 17-21 wherein said mar resistant material comprises, optionally consists of, a α-siloxane, a silicon nitride, a silicon oxycarbide, or combinations thereof.

29. The mar resistant thermoplastic material of any one of claims 17-21 wherein the mar resistant material comprises, optionally consists of, SiOₓ, Si₃N₄, SiC or other organosilicon compound, or combinations thereof.

30. An article of manufacture formed of the mar resistant thermoplastic material of any one of claims 17-29.

31. The article of manufacture of claim 30 in the form of a window or headlamp cover.

32. A process as described in the specification.

33. A material as described in the specification.
